(19) United States
(12) Patent Application Publication
(10) Pub. No.: US 2024/0403494 A1
(43) Pub. Date: Dec. 5, 2024

(54) Multi-Project Chip, Methods of Making, and Using the Same

(71) Applicant: NEOWINE Co., Ltd., Seongnam-si (KR)

(72) Inventors: Hyo Seung LEE, Seongnam-si (KR); Seen Suk KANG, Seongnam-si (KR); Youngtack SHIM, Seoul (KR); Tae Wook KIM, Seoul (KR)

(21) Appl. No.: 18/798,622

(22) Filed: Aug. 8, 2024

Related U.S. Application Data
(62) Division of application No. 18/089,524, filed on Dec. 27, 2022.

(30) Foreign Application Priority Data
Aug. 16, 2022 (KR) 10-2022-0101919

(51) Int. Cl. G06F 21/74

(52) U.S. Cl. CPC G06F 21/74

(57) ABSTRACT

This invention is about a multi-project chip or MP-chip that includes multiple individual units that can be selectively driven by multiple orders, and one or more common units that can be driven by two or more of the orders, respectively. In particular, the MP-chip may be installed inside the MP-chip or may be manufactured as a body separate the MP-chip or installed inside the MP-chip.

### CROSS-REFERENCE TO RELATED APPLICATIONS

This application is a Divisional application, pursuant to the provisions of 35 U.S.C. § 120, of prior U.S. patent application Ser. No. 18/089,524, filed on Dec. 27, 2022, and claims the benefit from Korean Patent Application No.: KR10-2022-0101919, filed on Aug. 16, 2022, in the Korean Intellectual Property Office, the disclosure of which is hereby incorporated by reference in their entireties.

### TECHNICAL FIELD

Aspects of the present invention relate to a multi-project chip or MP-chip, manufacturing method, and usage thereof that includes two or more individual units that can be selectively driven by each of two or more orderers, and one or more common units that can be driven with their individual units.

### BACKGROUND OF INVENTION

A well-known multi-project wafer semiconductor production arrangement (multi-project wafer semiconductor manufacturing arrangement, hereinafter abbreviated as “MPW arrangement”) is a semiconductor wafer including a product (e.g., a chip) produced by performing a number of different designs or projects while sharing masks and wafers, etc. by a number of orderers and a manufacturing method thereof, etc. collectively.

However, with the refinement of the process, the cost of identifying new products using known MPW arrays is also increasing exponentially.

A known MPW-chip produced by a known MPW arrangement may be considered as a composite of chips having a number of different designs, and such composite chips can be repeatedly arranged and produced throughout the wafer.

Using a known MPW arrangement, multiple orderers share with each other the cost of testing or testing the technical or efficient nature of a new product with a new structure, a new process, a new topology, etc., so that each orderer can minimize the cost incurred.

However, with the miniature process, the cost of identifying new products using known MPW arrays is also increasing exponentially.

For example, wafers are classified as 8-inch wafers, 12-inch wafers, etc. An 8-inch wafer refers to a round disk with a diameter of 8 inches. An 8-inch wafer has an area of 324 cm². Therefore, if the area lost at the edge is ignored, 324 semiconductors with a width×length of 1 cm x1 cm can be made with one 8-inch wafer.

Semiconductor exposing apparatus forms a pattern on a wafer using a mask and a photoresistor engraved with a semiconductor circuit pattern. The formation of a pattern in an area of 20 to 21 mm in width and length is called a unit photo shot, and a semiconductor circuit is formed by repeating exposure, etching, doping, and ion implantation on a wafer several times using a unit photo shot. Therefore, using photo shots with width and height of 21 mm each, 324 semiconductors with width and height of 7 mm can be made per wafer.

The known MPW arrangement is the operation of drawing several chips at once in an area of 2 cm each in width and height.

If the size of a normal circuit is 7×7 mm, a total of 9 chips can be formed at once, three in the horizontal and vertical directions, in an area of 21×21 mm² in one photoshop. If the initial development cost of 900 million won for masks (non-recurring engineering, or NRE) is required, it is shared among the nine project orderers, and each orderer can verify or test the new product by paying only 100 million won instead of 900 million won per project.

FIG. 1 is an example in which a plurality of orderers have produced a plurality of chips by each project in a single wafer using a known MPW array. However, for convenience of description, the sewing area between the different chips indicated by the large rectangle and the small rectangle in FIG. 1 is not shown.

In general, the products (i.e., chips) required by each orderer are repeatedly arranged on wafers of the same or different sizes.

In general, the products (i.e., chips) required by each orderer are repeatedly arranged on wafers of the same or different sizes. For example, on the wafer of FIG. 1, 10 new chips of 10 different orderers (A, B, C, D, E, F, P. Q, R, S) are regularly arranged on the wafer. Therefore, this structure generally corresponds to the case of fabricating 10 different chips required by the 10 orderers.

As such, orderers are spending IP usage fees for essential processes procured from outside, while using a known MPW arrangement to reduce initial development costs and focus on new product development.

However, due to process miniaturization, orderers struggled with IP usage fees that increased exponentially more than initial development costs. Of course, orderers can develop and use IP on their own, but with the development of process miniaturization, the cost of IP development and verification is increasing exponentially.

Therefore, the orderer uses IP from other companies to save IP development costs, and the price of verified IP is high and increases exponentially every year, resulting in more IP construction than initial development costs.

In addition, the orderer must also spend layout and backend related costs for semiconductor design. In particular, with the refinement of semiconductor processes, in particular, as semiconductor processes become finer, the orderer spends more on the backend that transforms logical designs into physical designs.

In other words, if verilog/analog circuit design and simulation is a front-end design, a back-end design corresponds to the task, i.e., operation, of connecting this logical circuit according to the use of electricity, physical connection, and the use of the system bus.

As the operating speed increases in these physical wiring, small differences in position or shape can improve or decrease the operating performance of the circuit, making it successful or failing. In the recent 14 nm process, dozens to hundreds of people have to simulate and fine-tune for more than several months for layout and back-end work. As a result, labor costs are rapidly increasing.

The mass production price of semiconductor wafers usually varies depending on the process and mass production quantity, for example, the mass production price per 12-inch wafer is about US $1,000˜4,000 (hereinafter referred to as “USD”). Since the area of the 12-inch wafer is 729 cm², 729 semiconductor chips of 10×10 mm in width and height can be mass-produced, that is 10,000×10,000 μm.

Of course, in an actual process, due to the decrease in yield at the edge of the wafer and in some areas, the number of mass production possibilities decreases, and considering this, about 500 chips can be produced on a 12-inch wafer. Assuming a cost of $4,000 per wafer, the cost of one chip is $8. In this case, if the initial development cost is $10 million, 1.25 million chips would need to be mass-produced to cost $8 per chip. Even without non-exclusive royalties for IP, it would be very difficult to make 1.25 million chips with the initial design. Since semiconductors undergo dozens of revisions and reviews in total, it is nearly impossible for a single orderer to test and mass-produce a chip at once without using a known MPW array.

The cost of designing a 5 nm process semiconductor is estimated to be around $50 million. Since the wafer price and chip price do not change much, if the cost of a particular chip is 8 dollars, the same 6.25 million chips must be mass-produced to reduce the initial development cost to about 8 dollars each. However, it is impossible to produce and sell 6.25 million new semiconductors used in servers.

If it were to be mass-produced on a 3 nm process, it would cost $1 billion to mass-produce, and even then, 125 million chips would need to be mass-produced to meet the development cost of $8 each.

It is impossible to mass-produce 100 million chips by initial mass production. However, a precision process accelerates, development costs relative to wafer costs and chip costs will increase at a faster rate.

Table 1 shows the initial development cost and return on investment (ROI) based on the degree of process scaling (nm), wafer diameter, wafer price, and the like when a known MPW array is used.

TABLE 1

| | RnD | | | | | Unit | | | | Prime |
|---|---|---|---|---|---|---|---|---|---|---|
| | Cost/ | | | Wafer | Mass | Price | ROI | | RnD | Cost |
| | USD | Wafer | Wafer | Area | Quantity | cm | 100K | SUM | Ratio | Ratio |
| Process | A | inch | Price | Square | B | C | A/C = D | A + D = E | D/E % | C/E |
| 130 | 500,000 | 8 | 1,000 | 324 | 10,000 | 3.1 | 50 | 53 | 94.16% | 5.84% |
| | | | | | 100,000 | | 5 | 8 | 61.73% | 38.27% |
| | | | | | 1,000,000 | | 0.5 | 4 | 13.89% | 86.11% |
| | | | | | 73,000,000 | | 0.007 | 3 | 0.229% | 99.78% |
| 14 | 10,000,000 | 12 | 3,000 | 729 | 10,000 | 4.1 | 1,000 | 1,004 | 99.59% | 0.41% |
| | | | | | 100,000 | | 100 | 104 | 96.06% | 3.94% |
| | | | | | 1,000,000 | | 10.0 | 14 | 70.92% | 29.08% |
| | | | | | 73,000,000 | | 0.137 | 4 | 3.2396 | 96.77% |
| 5 | 50,000,000 | 12 | 5,000 | 729 | 10,000 | 6.9 | 5,000 | 5,007 | 99.86% | 0.14% |
| | | | | | 100,000 | | 500 | 507 | 98.64% | 1.36% |
| | | | | | 1,000,000 | | 50 | 57 | 87.87% | 12.13% |
| | | | | | 73,000,000 | | 0.685 | 8 | 9.03% | 90.97% |
| 3 | 1,000,000,000 | 12 | 10,000 | 729 | 10,000 | 13.7 | 100,000 | 100,014 | 99.99% | 0.01% |
| | | | | | 100,000 | | 10,000 | 10,014 | 99.86% | 0.14% |
| | | | | | 1,000,000 | | 1,000 | 1,014 | 98.6596 | 1.35% |
| | | | | | 73,000,000 | | 14 | 27 | 50.00% | 50.00% |

For example, assuming that the initial development cost of the 3 nm scalification process is 1 trillion won, the unit price per chip will be 1,000 US dollars if 1 million chips are mass-produced in the initial period.

Thus, compared with the wafer chip price, the scale of the initial development cost is very huge. In other words, in order to satisfy the return on investment (ROI), an increase in the number of chip mass productions is essential.

Specifically, assuming that the initial development cost of the 130 nm, 14 nm, 5 nm, and 3 nm scalification processes is 500,000, 10 million, 50 million, and 1 trillion dollars, respectively, in the case of the 130 nm scalification process, the number of mass productions in which the chip cost is equal to the development cost parity (development cost/mass production quantity) is 100,000. In the case of the 14 nm miniaturization process, 1.8 million units must be mass-produced, so that the chip cost is equal to the development cost parity. The 5 nm miniaturization process must mass-produce 2.1 million units due to the increase in development cost, so that the chip cost is equal to the development cost parity. The 3 nm miniaturization process has a huge development cost, and 36 million units must be mass-produced, so that the chip cost is equal to the parity of the development cost. In the case of a 1.8 nm miniaturization process, the number of mass productions to make the chip cost and development cost parity equal will be further increased.

In addition, there are significant limitations in known MPW arrangements.

For example, even if the verification or testing of a new product is satisfactorily completed using the known MPW array, mass production using it is impossible. Therefore, the orderer has to bear additional costs such as repeating masks, photo shots, etc. for mass production.

In addition, when using a known MPW arrangement, multiple orderers cannot share hardware platforms, platform software, OS ports, system programs, PCB modules, interchip platforms of the same structure, and the like. Therefore, each orderer must have them separately and bear the IP cost for each.

In addition, when using a known MPW arrangement, each orderer will increase layout costs, backend costs, etc., and must bear all the development and costs of FA/HW solutions. In addition, each orderer may have to bear all the development costs for FA/HW solutions. In addition, depending on the orderer, it may be difficult to manage data and development processes.

Therefore, even if process miniaturization is further accelerated in the future, a multi-project chip with a new structure, a method of manufacturing, and using the same that can more effectively reduce the initial development cost are needed.

### EMBODIMENTS

### Problems to be Solved

Therefore, aspect(s) of the present invention is related to a multi-project chip (multi-project-chip or MP-chip) including two or more individual units that can be selectively driven by two or more orders, and one or more common units that can be driven with each individual unit, a method of manufacturing the same, and a method of using the same.

### Means for Solving Problems

aspect(s) of the present invention may include a multi-project chip (hereinafter abbreviated as “MP-chip”) including a plurality of individual units in which each of the plurality of orderers can selectively be driven by its own security element, and one or more common units that a plurality of orderers can drive with their own individual units.

For example, by placing the IP required for MP-chip mass production in the above common unit and allowing 10 different orders to share it, per chip when mass-producing 10 million chips, the price may decrease by 1/10, and the initial development cost may also decrease by 1/10.

As described above, the MP-chip of the present invention can reduce layout costs, back-end costs, IP costs, and the like by using a known MPW array. In particular, by optimizing the structure of the MP-chip, more orderers can share a specific MP-chip, thereby minimizing the cost to each orderer. Therefore, by drastically reducing the initial development cost of new chip development, orderers can dramatically strengthen their new chip development capabilities.

The MP-chip of the present invention may be implemented in the form of a single chip, or may be implemented in the form of a wafer equipped with the same plurality of MP-chips.

The MP-chip of the present invention may be implemented through the following exemplary aspects.

A multi-project chip of a first exemplary aspect thereof may include a first individual unit including at least one of a first hardware element and a first software element; a second discrete unit comprising at least one of a second hardware component and a second software component; and a common unit including at least one of a third hardware component and a third software component.

The first individual unit may be driven together with the common unit to execute a first operation, the first individual unit may not drive with the second individual unit when executing the first operation, The second individual unit may be driven together with the common unit to execute the second operation, and the second individual unit may not be driven with the first individual unit when executing the second operation.

At this time, the first individual unit may drive together with the second individual unit but not execute the first operation. Or the first individual unit may not include the second hardware element and the second software element. Or the second individual unit may not include the third hardware element and the third software element.

The first individual unit may drive together with the common unit to execute a first operation, but one of the third hardware element and the third software element may not drive. Or the first individual unit may not be directly electrically connected to the second individual unit. Or the first individual unit may not be indirectly electrically connected to the second individual unit.

The multi-project chip may include an additional common unit, the additional common unit may include one or more of a fourth hardware element and a fourth software element, and the first individual unit may be driven with the common unit and the additional common unit to execute a first operation.

When the multi-project chip receives a first signal from a user, the chip checks whether the first signal matches a pre-stored signal, and if the first signal matches the storage signal, the multi-project chip may drive the first individual unit and the common unit. However, if the first signal does not match the storage signal, the multi-project chip may not drive the first individual unit and the common unit.

At this time, the multi-project chip includes a first security element, but the security element may compare the first signal with the storage signal.

The second exemplary aspect of the multi-project chip thereof may include a first individual unit including one or more of a first hardware element and a first software element; a second individual unit including one or more of a second hardware element and a second software element; a common unit including one or more of a third hardware and a third party software elements; a first security element receiving a first signal for driving a first individual unit; and a second security element for receiving a second signal for driving a second individual unit.

In particular, when receiving the first signal, the first security element causes the first individual unit to drive together with the common unit to execute the first operation, and when the second signal is received, the second security element drives the second individual unit with the common unit to execute the second operation.

In addition, the first individual unit may not be driven together with the second individual unit when executing the first operation. Or the first individual unit may not be able to execute the first operation even if it is driven together with the second individual unit. Or the first individual unit may not include the second hardware element and the second software element. Or the second individual unit may not include the third hardware element and the third software element.

Alternatively, the first individual unit may drive together with the common unit to execute the first operation, but not drive one of the third hardware element and the third software element. Or the first individual unit may not be directly electrically connected to the second individual unit. Or the first individual unit may not be indirectly electrically connected to the second individual unit.

Or the multi-project chip may include an additional common unit, wherein the additional common unit includes one or more of a fourth hardware element and a fourth software element, and the first individual unit is driven together with the common unit and the additional common unit to execute a first operation. Or the first security element may be located in one of the upper, side and lower portions of the first individual unit.

The multi-project chip of the second exemplary aspect thereof can be manufactured by a method including the following various steps.

The method may include a first confirmation step of identifying a plurality of first elements of a first orderer intending to execute the first project; a second confirmation step of confirming a plurality of second elements of the second orderer intending to execute the second project; identifying common elements among the first and second elements; a first individual unit confirmation step of confirming the first remaining elements except one or more of the above common elements among the first elements; a first individual unit fabrication step for fabricating the first remaining elements into a circuit on a wafer; a second individual unit fabrication step of fabricating the second remaining elements as a circuit on a wafer; and a common unit manufacturing step of fabricating the common elements as a circuit on a wafer.

Therefore, when the first orderer drives the first individual unit and the common unit together, the first orderer may execute the first project, and when the second orderer drives the second individual unit and the common unit together, the first orderer may execute the first project.

In this case, the first elements may include one or more of one or more first hardware elements and one or more first software elements

The first individual unit confirmation step may include a first individual unit reduction confirmation step for confirming the first remaining elements except all of the common elements among the first elements. Or the method may include a direct connection step of directly electrically connecting the first individual unit and the common unit.

The method may include a first security step of providing a first signal to the first individual unit and the multi-project chip to drive the first individual unit and the common unit together by the first orderer.

### Effects of the Invention

The MP-chip of the present invention can use the backend and the front end for verification or testing of a new chip for mass production of the same chip. Therefore, the back-end and front-end of the MP-chip of the present invention can be used for mass production immediately after a prototype test run.

When using the MP-chip of the present invention, a plurality of orderers may share one or more of a hardware platform, platform software, OS porting, system program, PCB module, factory automation (FA)/HW solution, interchip platform of the same structure, backend portion of the main platform, and the like.

Accordingly, when using the MP-chip of the present invention, a plurality of orderers may share one or more of the IP for various hardware (hereinafter abbreviated as “H/W”) elements, software (hereinafter abbreviated as “H/W”) elements illustrated in the above paragraph, installed in a common unit of the MP-chip.

As a result, when N orderers share the MP-chip of the present invention together, each orderer may reduce one or more of various costs such as backend, frontend, and layout cost, as well as reduce the initial development cost to approximately 1/N. In addition, each orderer may use the MP-chip of the present invention to manage data, development process, etc. as a system.

In addition, even if the process is further precise to 2 nm, 1.8 nm, etc., each orderer can more effectively reduce the initial development cost by using the MP-chip together with other orderers.

The term “orderer” in this specification generally refers to a fabless company that can design chips but does not have the facilities to produce them.

The term “manufacturer” of the present specification generally refers to a company capable of actually producing an MP-chip of the present invention, for example, a foundry. However, the “orderer” in this specification may include “manufacturer”.

In addition, the term “other company” in this specification means a company that supplies an H/W element or an S/W element necessary for the production of the MP-chip of the present invention to an orderer or manufacturer. For example, a company that provides services related to EDA (electronic design automation) tools or other processes required for MP-chip production is an example of a “third party.”

However, in order for the orderer or the manufacturer to use various H/W elements or S/W elements provided by “other companies”, it may be necessary to purchase the elements from “other companies” or to obtain permission such as a license to drive the elements.

### BRIEF DESCRIPTION OF THE DRAWINGS

FIG. 1 is an example of producing chips by each project on a single wafer using a known MPW array by multiple orderers.

FIG. 2 is a schematic diagram functionally showing the configuration of an MP-chip of the present invention including a plurality of individual units and one common unit.

FIG. 3 is a schematic diagram functionally showing another configuration of the MP-chip of the present invention comprising a plurality of individual units and one common unit.

FIG. 4 is a schematic diagram functionally showing the configuration of an MP-chip of the present invention including a plurality of individual units and a plurality of common units.

FIG. 5 shows a common unit including a plurality of individual units, a plurality of H/W elements and a plurality of S/W elements that two or more individual units can drive together, respectively. An example of an artificial intelligence MP-chip of the invention.

FIG. 6 is a plan view (or cross-sectional view) showing a physical example of the artificial intelligence MP-chip of the present invention illustrated in FIG. 5.

FIG. 7 is a schematic diagram functionally showing the MP-chip of the present invention having a structure in which a specific individual unit can drive all common H/W elements and common S/W elements included in a common unit.

FIG. 8 is a schematic diagram showing the functionality of MP-chip which has a structure in which common elements of the first group and common elements of the second group are disposed in different parts of a common unit, and is required a permission for individual units to drive the common elements of each group according to aspects of the present invention.

FIG. 9 shows an MP-chip including a plurality of individual units and a single common unit designed by a plurality of orderers and is a schematic diagram of a configuration in which a security element corresponding thereto is installed in each individual unit according to aspects of the present invention.

FIG. 10 shows an example of an MP-chip containing a number of individual units and a single common unit designed by a number of orderers, and each individual unit is a schematic diagram of a configuration driven by security elements, an object separated from the MP-chip.

FIG. 11 is a schematic diagram of a wafer in which a plurality of identical MP-chips are arranged according to an embodiment of the present invention.

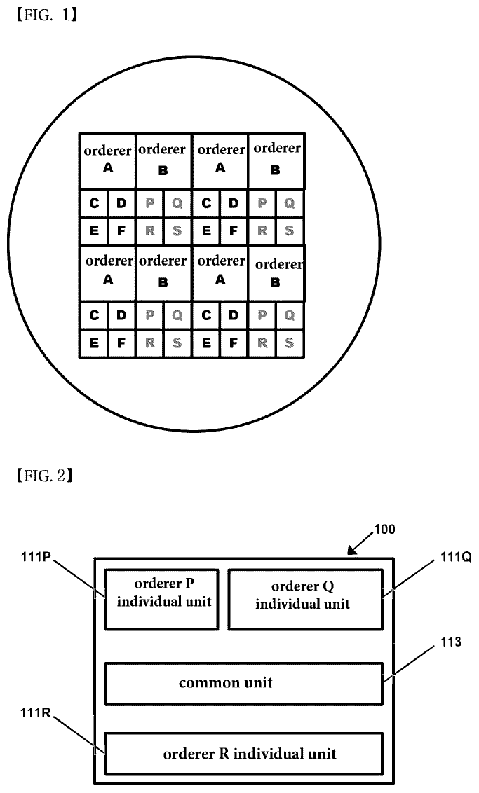

### DETAILED EMBODIMENTS

Hereinafter, with reference to the accompanying drawings, preferred exemplary aspects, practical examples and detailed examples of the present invention will be described in detail. However, in describing the present invention, the description of functions or configurations already announced will be omitted in order to clarify the gist of the present invention.

The following description relates to various exemplary aspects, examples, and detailed examples of a multi-project-chip (hereinafter, abbreviated as “MP-chip”) of the present invention, a manufacturing method thereof, and a use method thereof. In particular, the present specification describes characteristics of structure, manufacture, and use of one or more individual units included in the MP-chip, one or more common units, and various elements included in the units.

Although the present specification refers to the accompanying drawings and descriptions, various exemplary aspects, embodiments, and detailed examples of the MP-chip of the present invention and various units and elements thereof, methods of manufacturing and using thereof, correspond only to different forms.

Therefore, the MP-chip and various units and elements thereof may have different structures or may be installed at different locations, and the manufacturing method or method of use may include or be replaced thereby in different modes, different sequences, or different steps.

Therefore, various MP-chips and their various units, elements, and various manufacturing methods thereof or use methods for the MP-chips, units, elements, etc. of the present invention are not limited to various exemplary aspects, examples, and detailed examples described above and below. Rather, various exemplary aspects, embodiments, and detailed examples of this invention are to explain (1) various MP-chips, (2) various units and elements of the MP-chip, (3) how to manufacture the MP-chip, unit, and element, or (4) how to use the MP-chip, unit, and element to clearly inform the scope thereof.

Unless otherwise noted, the drawings of the present specification may not show various units, elements, sub-units, etc. of the MP-chip of the present invention in actual size or ratio for convenience of description. In addition, units, elements, or parts marked with the same number in the drawings below, and their manufacturing order or order of use are the same, similar, or functionally equivalent.

The drawings herein complement the description of various exemplary aspects, embodiments and detailed examples of various MP-chips, structures of units or elements thereof, manufacturing methods, methods of use, and the like. In particular, the numbers marked between “(” and “)” in the drawings of the present specification, for example, (10), (20), and (30), indicate elements, units, parts, and the like illustrated in the drawings.

If numbers are represented between “[” and “]” herein, it means that they are alternatives to each other. Thus, the expression “the common unit may be installed only inside [1] of the MP-chip, only at the edge of [2], or in a combination of [1] and [2] in front of [3]” means that the common unit may be installed only inside the wafer, only at the edge of the wafer, or at both the inside and the edge.

Various exemplary aspects, embodiments and detailed examples of various units, elements, or parts of the MP-chip of the present invention and methods for making or using the same are not intended to limit the method of making or using the MP-chip, the unit or the element. Accordingly, exemplary aspects of the present invention, embodiments and detailed examples of MP-chips, the structure, installation location or installation method of units, elements or parts thereof can also be modified as long as they do not depart from the spirit and scope of the present invention.

Various exemplary aspects, embodiments and detailed examples of various units, elements, or parts of the MP-chip of the present invention and methods of making or using the same may differ from each other, but are not exclusive to each other.

Therefore, MP-chip of a specific example, example or detail, unit, element or part of the MP-chip, and their structure, features, functions, manufacturing methods, manufacturing procedures, usage procedures, etc. can also be applied to different examples, different examples, or different detailed examples unless [1] they conflict with each other, or [2] do not depart from the spirit or scope of the various MP-chips of the present invention. However, at this time, depending on the detailed context, a specific unit, a specific element, a specific part of the MP-chip, and the structure, characteristics, manufacturing method, manufacturing sequence, method of use, or order of use thereof, [1] may be modified, [2] a part may be produced, or [3] additional structures may be added to a part.

The first exemplary aspect of this invention is the configuration of the MP-chip of this invention, which includes multiple individual units and one or more common units, each of which is required by multiple orderers to perform a specific task by driving one or more common units together.

FIG. 2 is a schematic diagram functionally showing the exemplary configuration of the MP-chip 100 of the present invention, which includes a plurality of individual units 111P, 111Q, 111R and one common unit 113. However, the area and location of the individual units 111P, 111Q, 111R and the common unit 11 of the MP-chip 100 are only examples, and the area and location of the individual units 111P, 111Q, 111R and the common unit 113 may be different from FIG. 2.

In addition, for convenience of description, in FIG. 2, physical or functional connections between individual units of the MP-chip 100 using hardware H/W, software (S/W), physical or functional connections between common units, or physical or functional connections between individual units and common units are omitted.

The individual units 111P, 111Q, 111R and the common unit 113 may include various H/W or S/W elements, examples of which include detailed processes or elements of a back-end process or a front-end process, various platforms, programs, modules, solutions, IPs, and the like, and in addition, various H/W or S/W elements included in the known chip may also be included in the individual unit or common unit.

Therefore, when the individual unit 111P and the common unit 113 of the MP-chip 100 of FIG. 2 are driven together, the MP-chip 100 may be considered as a chip of P that executes the operation required by the orderer P. In addition, if the individual unit 111Q and the common unit 113 are driven together, the MP-chip 100 may be considered a chip of Q that executes the operation required by the orderer Q. Similarly, when the individual unit 111R and the common unit 113 are driven together, the MP-chip 100 may be considered a chip of R that executes the operation required by the orderer R.

The expression “individual units drive or drive together with common units” herein does not mean the temporal characteristics of the drive. That is, the expression “driving together” described above refers to “one or more of the H/W elements or S/W elements included in a particular individual unit and one or more of the H/W elements and S/W elements included in a common unit in any order, The individual unit and the common unit perform a specific operation required by the orderer who designed the individual unit.”

Thus, when a specific individual unit (for example, “P”) and one H/W element (for example, “H/W₁”) and two S/W elements (for example, “S/W₁ and S/W₂”) included in a common unit “drive together” to execute a specific task, the execution of the task means that multiple steps are performed simultaneously, sequentially or in combination thereof.

For example, the execution may be performed sequentially in the order of P-H/W₁-S/W₁-S/W₂, P-H/W₁-S/W₂-S/W₁, P-S/W₁-H/W₁-S/W₂, H/W₁-S/W₂-P-S/W₁ or P-H/W₁-S/W₂-H/W₁-S/W₁. Alternatively, during the execution, two or more steps among P, H/W₁, S/W₁, and S/W₂ in the order of the preceding operation may be performed simultaneously.

In addition, in order for a particular individual unit to drive together with a common unit to perform a specific task, a specific element of an individual unit or a common unit may be repeated more than once.

Accordingly, when producing masks, photo shots, etc., MP-chip manufacturers only need to produce H/W elements and S/W elements included in the common unit once, regardless of the number of orderers. As a result, MP-chip manufacturers as well as each orderer can minimize layout costs, back-end costs, or front-end costs associated with the various elements included in a common unit.

That is, when using a known MPW arrangement, even if the H/W element or S/W element required by each orderer is the same when producing masks, photo shots, etc., the MP-chip manufacturer must repeatedly produce the above elements. However, when producing masks, photo shots, etc., MP-chip manufacturers only need to produce H/W elements and S/W elements commonly driven by two or more orderers once, and then include these elements in a common unit, thereby minimizing the cost and time associated with them.

As described above, the MP-chip 100 of FIG. 2 is configured to execute a specific operation when each individual unit 111P, 111Q, and 111R is driven together with the common unit 113. When each individual unit (111P, 111Q, 111R) of the MP-chip 100 can execute each specific task only when all H/W elements and S/W elements included in the common unit 113 are driven together.

As described above, all the individual units included in the MP-chip 100 are referred to as “common H/W elements or common S/W elements” that drive together to execute each specific operation, and the “common H/W element or common S/W element” is collectively referred to as “common elements.”

The first embodiment of the first exemplary aspect relates to the selection or configuration of individual units and common units of the MP-chip of the present invention.

For example, assume that orderer P's product requires 10 H/W elements and 15 S/W elements, orderer Q's product requires 15 H/W elements and 20 S/W elements, and orderer R requires 15 H/W elements and 20 S/W elements, and the product of requires 20 H/W elements and 25 S/W elements, 7 of the 45 H/W elements are the same, and 10 of the 60 S/W elements are the same.

The MP-chip 100 arranges 7 H/W elements, which are common elements among 45 H/W elements, in the common unit 113, while the remaining H/W elements 3 are placed in the individual unit 111P of the customer P, the remaining 8 H/W elements may be placed in the individual unit 111Q of the orderer Q, and the remaining 13 H/W elements may be placed in the individual unit 111R of the orderer R.

Similarly, the MP-chip 100 discloses 10 S/W elements, which are common elements among 60 S/W elements, to the common unit 113, while the individual unit 111P of the orderer P includes the remaining 5 S/W elements, the individual unit 111Q of the orderer Q may have the remaining 10 S/W elements, and the individual unit 111R of the orderer R may be disposed of the remaining 15 S/W elements.

Of course, the MP-chip 100 does not need to place all of the common H/W elements or common S/W elements in the common unit 113. Therefore, in the above example, the MP-chip 100 places only 7 out of 10 common elements required by orderer P, orderer Q, and orderer R in the common unit 113, the remaining three common elements may be redundantly arranged in each individual unit.

The second embodiment of the first exemplary aspect relates to another selection or configuration of individual units and common units of the MP-chip of the present invention.

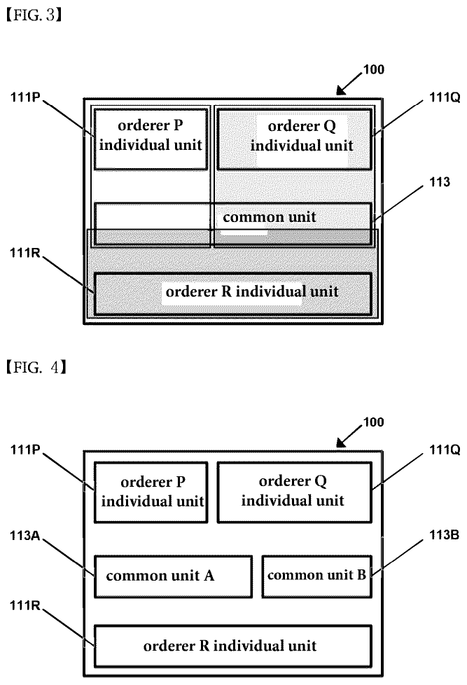

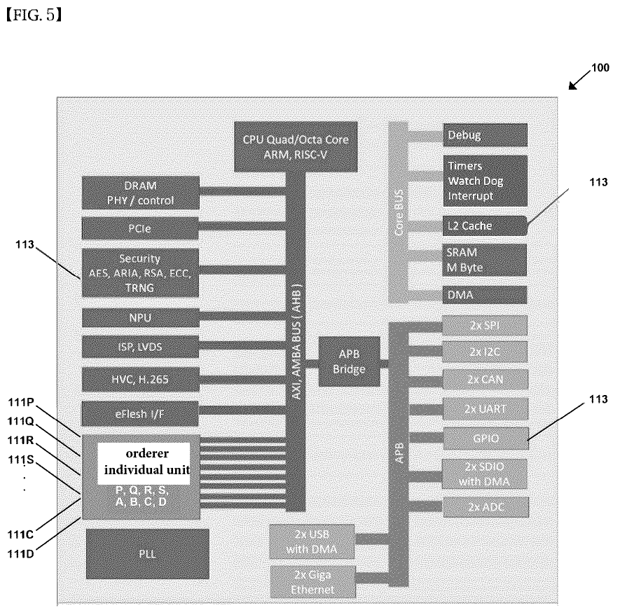

FIG. 3 includes a plurality (for example, three) individual units 111P, 111Q, 111R and one common unit 113 as shown in FIG. 2, but each individual unit 111P, 111Q, 111R is driving a different H/W element or a different S/W element included in the common unit 113 A schematic diagram of a functional representation of the configuration of the MP-chip 100 of the present invention.

However, in FIG. 3, instead of specifically or displaying different H/W and S/W elements driven together with each individual unit 111P˜111R, the elements were displayed in different positions and areas. Therefore, H/W elements or S/W elements included in different positions of a particular unit can be considered to be different from each other.

The area, location of the individual units 111P, 111Q, 111R and the common unit 113 of the MP-chip 100 of FIG. 3 are only examples according to aspects of the present invention, and therefore, when manufacturing the MP-chip 100, the area and location of the individual units 111P, 111Q, 111R and the common unit 113 may be different from FIG. 3.

Unlike the individual unit of FIG. 2, the individual unit 111P of FIG. 3 is not the whole of the common unit 113, but a part, for example, it is configured to execute a specific task by driving together with H/W elements and S/W elements disposed on the left side of the common unit 113.

In addition, the individual unit 111Q is configured to execute a specific task by driving a portion rather than the whole of the common unit 113, for example, an H/W element and an S/W element disposed on the right side of the common unit 113.

Similarly, the individual unit 111R is configured to execute a specific task by driving a portion of the common unit 113 rather than the whole, for example, an H/W element and an S/W element disposed at the bottom of the common unit 113.

In other words, when the MP-chip 100 includes N separate units, the common unit 113 of this second embodiment includes one or more H/W elements or S/W elements driven together with at least two or more individual units.

In addition, the common unit 113 of the second embodiment includes one or more H/W elements or S/W elements that the specific individual units do not drive together when driven together with at least one specified individual unit.

As such, although not all individual units drive together, the H/W element or S/W element in which two or more individual units drive together to perform a specific task is hereinafter referred to as a “partial common H/W element or a partial common S/W element”, and the “partial common H/W element or partial common S/W element” is collectively referred to as a “partial common element”.

From this point of view, the common use of the first embodiment of this exemplary aspect may be considered to include one or more common H/W elements or common S/W elements corresponding to a kind of maximum common divisor required for a plurality of individual units to drive.

On the other hand, the common unit of the second embodiment of this exemplary aspect may be considered to include a partial common H/W element or a partial common S/W element corresponding to a kind of common multiple or least common multiple, in which at least two individual units drive together, although not all individual units drive together.

The third embodiment of the first exemplary aspect relates to a configuration of an MP-chip of the present invention including a plurality of individual units and a plurality of common units.

FIG. 4 is a schematic diagram functionally showing the configuration of the MP-chip 100 of this invention, which includes a plurality of individual units 111P, 111Q, 111R, and a plurality of common units 113A and a second common unit 113B.

However, the area, location, etc. of the individual units 111P, 111Q, 111R, the first common unit 113A, and the second common unit 113B of the MP-chip 100 are only examples, and the area, location, etc. of the units 111P, 111Q, 111R, 113A, and 113B may differ from FIG. 4.

The MP-chip 100 of FIG. 4 is similar to the MP-chip of FIG. 2 and FIG. 3, but has a difference in that it includes two common units 113A and 113B. In this case, the first and second common units 113A and 113B may include one or more identical H/W elements or the same S/W elements. Alternatively, the common unit 113A may include one or more H/W elements or S/W elements not included by the common unit 113B.

The MP-chip manufacturer may install two or more common platforms in the MP-chip 100 for various reasons.

First, by physically properly arranging a plurality of common units, various units or elements may be more easily electrically connected.

For example, according to the structure of the MP-chip 100 of FIG. 4, the MP-chip manufacturer can more easily electrically connect the individual unit 111P of the orderer P to the common unit A 113A, and the individual unit 111Q of the orderer Q to the common unit 113B more easily.

Second, when the number of orderers increases and the number of individual units increases accordingly, a plurality of common units are used instead of using a single common unit, and each common unit includes H/W elements or S/W elements required by a plurality of adjacent individual units, so that the MP-chip manufacturer can more easily design and manufacture the MP-chip.

Third, MP-chip manufacturers can reduce the design, fabrication, or validation costs required to upgrade common H/W elements, common S/W elements, partial common H/W elements, and partial common S/W elements by installing multiple common units.

For example, an MP-chip manufacturer may include an H/W element or an S/W element that is not upgraded relatively often (common or partially common) H/W element or S/W element in the first common unit, while a frequently upgraded (common or partially common) H/W element or S/W element may be included in the second common unit.

Accordingly, even when the MP-chip manufacturer redesigns and manufactures the second common unit to upgrade a specific element included in the second common unit, the first common unit may be manufactured using a known design.

Fourth, by installing a large number of common units, MP-chip manufacturers can more easily solve problems related to permits (such as patents or trade secret licenses) related to the operation of H/W elements or S/W elements manufactured by other companies and protected by IP.

For example, if there are different H/W elements or S/W elements that a number of orders must operate with each individual unit (which must be licensed from another company), Depending on the type or scope of permission received by each orderer, the type of authorized H/W element or S/W element, and the like, the H/W elements or S/W elements may be included in different common units. Thus, MP-chip manufacturers can more easily manage to drive only H/W elements or S/W elements for which each orderer has obtained permission, for example, a license.

The fourth embodiment of the first exemplary aspect is directed to an example of a functional structure of an artificial intelligence MP-chip manufactured according to this exemplary aspect of the present invention.

FIG. 5 shows an example of an artificial intelligence MP-chip 100 of the present invention, which include a plurality of individual units 111P, 111Q, 111R, 111S, 111A, 111B, 111C, 111D, etc., a plurality of common or partially common H/W elements driven by two or more individual units, and a common unit 113 in which a plurality of common or partially common S/W elements, and the like are disposed.

In particular, FIG. 5 illustrates a structure in which individual units 111P˜111S and 111A˜111D designed by a plurality of orderers are electrically connected to one or more BUSs. Accordingly, the individual units may share various IPs such as O/S IP, application IP, and the like.

In addition, the common unit 113 of FIG. 5 may include CPU core, DRAM, PCI express, neutral processing unit (NPU), image signal processor (ISP), low-voltage Differential signaling (LVDS), high-efficiency video coding (HeVC), eFLASH, phase-locked loop (PLL), debug, timer, watchdog, interrupt, cache, H/W elements such as security elements, and a plurality of S/W elements, and the like.

Thus, each individual unit 111P˜111S, 111A˜111D may be driven with one or more of the various common or partial H/W elements or a plurality of common or partial S/W elements contained in the common unit 113 to execute the specific work required by each orderer P, Q, R, S, A, B, C, D.

Although not shown in FIG. 5, a plurality of common or partial cavity) H/W elements and a plurality of common or partially common S/W elements may be included in a single common unit or may be duplicated in a plurality of common units. Or each common or partially common element may be included only once in one of a plurality of common units.

When the MP-chip 100 includes a plurality of common units, each common unit may include one or more common or partial cavity H/W elements or one or more common or partially common S/W elements that two or more individual units can drive together. Thus, each of two or more common units may include one or more identical H/W elements or the same S/W elements.

In contrast, a specific common or partially common H/W element or common or partially common S/W element may be included in one or more common units, but may not be included in one or more other common units.

Although it may vary depending on the number of common units and the structure of various units (for example, electrical connection of the units, etc.), each individual unit may be directly or indirectly electrically connected to a plurality of H/W elements and S/W elements included in the common unit. Alternatively, one or more individual units may not be electrically connected to one or more H/W elements or one or more S/W elements included in a common unit.

The fifth embodiment of the first exemplary aspect is directed to an example of the physical structure of the MP-chip of the present invention of the fourth embodiment.

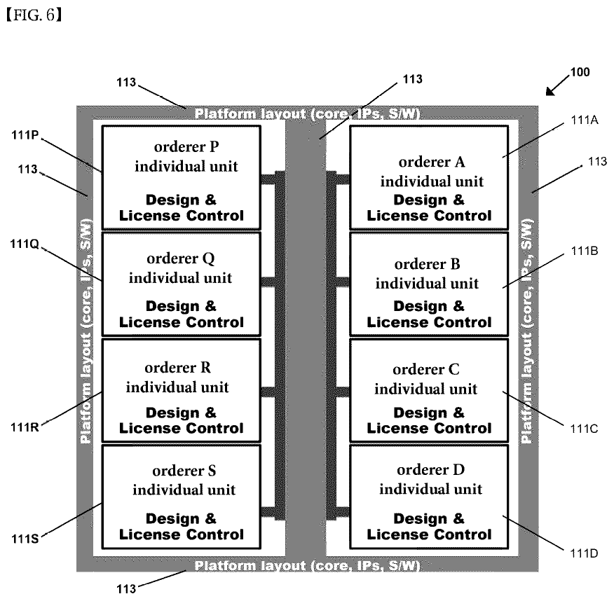

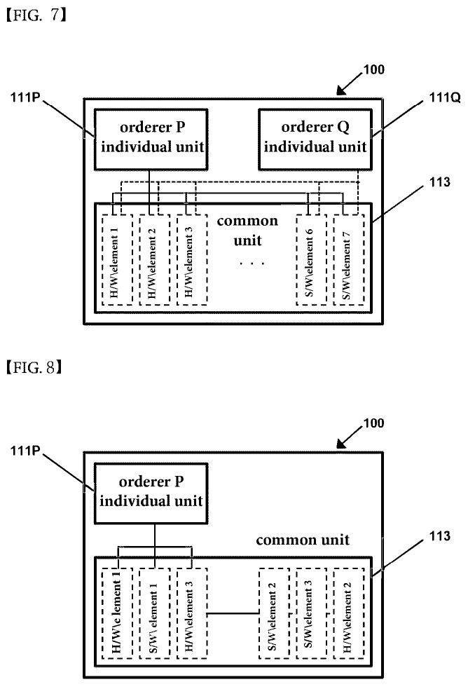

FIG. 6 is a floor plan (or cross-sectional view) illustrating the physical structure of the MP-chip 100 illustrated in FIG. 5. First, the MP-chip 100 of FIG. 6 may include a total of eight individual units (111P˜111S, 111A˜111D) and a single common unit 113 designed by a total of eight orderers such as orderers P, Q, R, S, A, B, C, and D.

In particular, the individual units 111P˜111S and 111A˜111D of a total of eight orderers have (almost) the same shape and area, and four are disposed on the left and right sides of the MP-chip 100.

For convenience of explanation, in FIG. 6, the individual units 111P˜111S and 111A˜111D are illustrated as having approximately similar sizes, but the size, shape, etc. of the individual units may be different, and thus the positions of the individual units 111P˜111S, 111A˜111D may also be different.

The common unit 113 of FIG. 6 is disposed at the edge and center of the MP-chip 100, and the common unit 113 is mainly suitable for a platform layout including a core, IP, S/W, and the like.

In addition, each individual unit 111P˜111S and 111A˜111D is electrically connected (indicated in green) with a common unit in the center of the MP-chip 100. However, each individual unit 111P˜111S and 111A˜111D may be electrically connected to a common unit at an edge other than the center of the MP-chip 100.

Various embodiments of the MP-chip of the present invention, various units and elements thereof, structures, manufacturing methods or methods of use, and the like illustrated in the first exemplary aspect of the present specification may be variously modified or improved.

The first embodiment of modification or improvement of the first exemplary aspect relates to various structures, fabrication methods, and methods of use of common units of the MP-chip of the present invention.

The common unit included in the MP-chip illustrated in FIGS. 2 to 6 may include one or more common (or partially common) H/W elements or one or more common (or partial cavity) S/W elements.

However, as described above, the “common (or partial) H/W element” or “common (or partial) S/W element” refers to an element in which all (or not all, but not all) of a plurality of individual units included in a particular MP-chip drive together with the individual units to execute the work desired by their orderers

However, the common unit of the MP-chip of the present invention may include a hollow (or partially common) H/W or S/W element in various structures or arrangements.

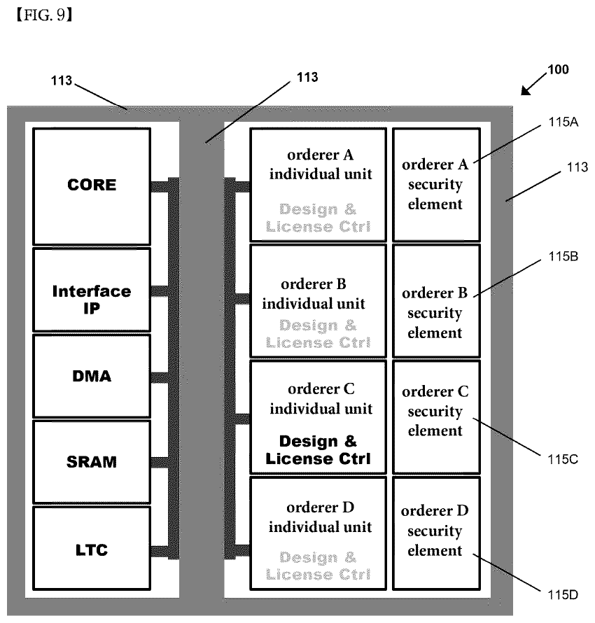

FIG. 7 is a schematic diagram of an MP-chip 100 having a structure in which an individual unit 111P and another individual unit not shown for convenience of description can drive all H/W and S/W elements included in the common user 113, respectively.

In this respect, the H/W elements and the S/W elements of the common unit 113 can be considered as common elements.

For convenience of description, only two separate units 111P and 111Q are shown in FIG. 7, but the MP-chip 100 may additionally include one or more separate units. Similarly, the MP-chip 100 may further include one or more common units.

In addition, the common unit 113 of the MP-chip 100 of FIG. 7 includes seven common H/W elements and seven common S/W elements.

However, for convenience of explanation, FIG. 7 shows only three H/W elements (i.e., H/W1, H/W2, and H/W3) and two S/W elements (i.e., S/W1 and S/W2). In addition, the electrical connection between the H/W elements and the S/W elements is omitted.

All common (H/W or S/W) elements included in the common unit 113 of the MP-chip 100 of FIG. 7 are disposed so that they can be driven together by each of the two separate units 111P and 111Q. In this respect, the common unit 113 of FIG. 7 may be considered to be composed of a single sub-unit.

Of course, in some cases, the individual unit 111P or the individual unit 111Q may be configured not to be driven together with a specific H/W element or a specific S/W element of the common unit 113. In this case, the particular element may be considered a partial common element, while the remaining elements of the common unit 113 may be considered as common elements.

FIG. 8 is a schematic diagram functionally showing an MP-chip 100 having a structure capable of driving the rest of the common elements after a specific individual unit 111P drives some of the common H/W elements included in the common unit 113.

For convenience of explanation, only a single individual unit 111P is displayed in FIG. 8, but the MP-chip 100 may additionally include one or more individual units, one or more common units, and the like.

In addition, the common unit 113 of the MP-chip 100 of FIG. 8 may include three common H/W elements and three common S/W elements. However, for convenience of description, the electrical connection between the H/W elements and the S/W elements has been omitted.

The individual unit 111P of the MP-chip 100 of FIG. 8 may be driven together with common elements of the first group (for example, H/W₁, S/W₁, H/W₃, etc.) of all common (H/W or S/W) elements included in the common unit 113. Thereafter, subject to various security-related requirements, the individual unit 111P may be driven with the public elements of the second group (i.e., the remaining common elements S/W₂, S/W3 and H/W2).

For example, when the individual unit 111P receives permission from another company 1 that supplied the elements to operate with the common elements of the first group, the individual units 111P may simultaneously or sequentially drive the common elements included in the first group. However, unless the individual unit 111P has the permission of another company 2 to drive the common elements included in the second group, the individual unit 111P cannot drive any common elements of the second group.

In this respect, the common unit 113 of FIG. 7 may be considered to be composed of a plurality, that is, two sub-units sequentially connected.

The second embodiment of a modification or improvement of the first exemplary aspect relates to various individual units and various orderers implemented in the MP-chip of the present invention.

In general, when N orderers jointly manufacture the MP-chip of the present invention, the number of orderers and the number of individual units including the MP-chip are 1:1. In addition, the MP-chips generally may include N separate units and one or more common units.

However, certain orderers may implement two or more different designs on the MP-chip. Therefore, in this case, the number of orderers and the number of individual units are N: n, where n represents the natural number less than N. That is, the MP-chip includes N individual units, but the number of orderers is less than N.

In addition, in general, when multiple orderers implement each individual user on a single MP-chip, each orderer may take security measures such as installing a security element to prevent other orderers from driving the individual units implemented by him/herself. Therefore, when N orderers jointly produce the MP-chip of the present invention, the number of orderers and the number of security elements on the MP-chip may also be 1:1.

However, if a particular orderer implements two or more identical designs on the MP-chip, the number of orderers and the number of security elements on the MP-chip are N: n, where n represents a natural number equal to N or less than N.

The third embodiment of the modification or improvement of the first exemplary aspect relates to the number of individual units and common units included in a particular MP-chip.

The FIG. 2, 3, 5 and FIG. 6 are cases where the MP-chip includes a single common unit, while FIG. 4 is when the MP-chip includes two common units. However, the MP-chip of the present invention may include three or more common units.

For example, as a precision process is intensified and a 2 nm process, a 1.8 nm process, or a further precision process is developed, the size of the individual units may decrease, and accordingly, more orderers may jointly develop MP-chips. As the number of individual units included in the MP-chip increases, it may be difficult to make an electrical connection between a plurality of individual units or between the individual units and the common units.

In this case, the MP-chip may include three, five or more common units. In addition, in extreme cases, a configuration or a large configuration is possible in which the number of common units included in a particular MP-chip is the same as the number of individual units included in the chip.

The fourth embodiment of the modification or improvement of the first exemplary aspect is for the additional advantage of having multiple orderer jointly develop and manufacture MP-chips.

For example, when N orders jointly develop the same MP-chip, there is an advantage that the initial development cost of the chip can be reduced to (almost) 1/N level as described above. In addition, it has the advantage of being able to verify IP individually or jointly or upgrade various SW elements, and when many orders collaborate, it can reduce the cost of trial and error or reduce development time by sharing feedback.

The fifth embodiment of the modification or improvement of the first exemplary aspect is its compatibility.

That is, each embodiment or detailed example of the first exemplary aspect of the above description may be [1] compatible with different embodiments or detailed examples of the first exemplary aspect of the above, or [2] may be mutually compatible with the embodiments or details of different aspects described below.

Therefore, unless the specific structure or method of the various embodiments and detailed examples of the first aspect above contradicts each other, according to aspects of the present invention may be [1] Applicable to different embodiments of the same aspect or equivalent or similar structure or method of detailed examples, [2] different aspects of the same aspect are applied to one embodiment or equivalent or similar structure or method of different detailed examples, [3] included in the corresponding or similar structure or method of [1] or [2] above, [4] substituted by the corresponding or similar structure or method of [1] or [2], [5] replaced by the corresponding or similar structure or method of [1] or [2], or [6] may be mixed with the corresponding or similar structure or method of [1] or [2].

The second exemplary aspect of the present invention relates to a security element associated with one or more common units included in the MP-chip of the present invention or a security element associated with one or more individual units of a plurality of individual units included in the MP-chip.

Various problems related to security may arise when making or using the MP-chips of the present invention, including a plurality of individual units implemented by one or more common units and the design of a number of different orderers.

The first of these security-related problems is related to the security of each individual unit independently developed by a number of orderers.

If the MP-chip of the present invention, including a number of individual units designed by multiple customizers, is freely operated by a large number of different orderers, serious security problems may occur.

For example, if the orderer Q can freely drive the individual unit P implemented in the MP-chip by the orderer P without the consent of the orderer P, the orderer Q may steal the technology, know-how, trade secret, IP, etc. of the orderer P included in the individual unit P.

In addition, the manufacturer of the MP-chip may also steal the technology, know-how, trade secrets, IP, etc. of various orderers while manufacturing the chip.

To solve this security problem, the MP-chip of the present invention uses various security elements to take various security measures, so that different orderers cannot drive individual units of a specific orderer including technology, know-how, trade secrets, IP, etc. of a specific orderer unless the specific orderer permits.

The second of the security-related problems is related to the security of the common unit included in the MP-chip of the present invention.

As described above, the orderer needs to obtain permission from the other company to use various H/W sources or S/W elements in which the other company has IP.

Therefore, it is possible to obtain licenses for various H/W elements and S/W elements that are commonly used by a large number of orderers who jointly produce MP-chips. Of course, in this case, there are no special security problems. However, if a common unit includes M H/W elements and N S/W

elements, most orders may have obtained permission from other companies for all (M+N) elements, but some orders have obtained permission for elements belonging to Group 1 which are part of (M+N) but not for Group 2.

When some of the orders are made to drive all (M+N) elements, there is a problem that some of the orders may drive the elements of the second group without the permission of another company with IP or without paying royalties to another company.

Accordingly, the MP-chip, various units, or elements of the second exemplary aspect of the present invention can be solved or minimized by manufacturing and using security elements having various structures in various ways.

The first embodiment of the second exemplary aspect relates to the security of various H/W elements or S/W elements included in a common unit of the MP-chip, wherein individual units can drive all H/W elements or all S/W elements contained in a single common unit or multiple common units without restriction. Therefore, the H/W elements or S/W elements can be regarded as common elements.

In the first detailed example of the first embodiment, a plurality of orderers each obtain a license for the common elements from another company(s), and the MP-chip manufacturer may include only common H/W elements or common S/W elements that the orderers have already obtained permission to include once or in multiple common units.

Accordingly, each of the plurality of individual units designed by a plurality of orderers drives together various common H/W elements or common S/W elements included in a single common unit or a plurality of common units without any limitation as shown in the example of FIG. 2 to execute a specific operation required by each orderer.

To this purpose, multiple orderers may obtain permission from other company(s) that individually or collectively have IP for various common H/W elements or common S/W elements included in a common unit.

Alternatively, the MP-chip manufacturer may obtain a license for the common elements from the other company(s) and then charge a plurality of orderers for the same.

The second detailed example of the first embodiment is when the common elements for which multiple orderers have obtained permission are not exactly identical to each other. However, even in this case, the first detailed example can be applied.

For example, it is assumed that orderer P, Q, and R obtain permission for different H/W elements or S/W elements from other companies(s), but orderer P and Q do not require H/W_{R} among H/W elements that order R has obtained permission.

In addition, orderer Q and R may not require S/W_{P} among S/W elements that order P has obtained permission, whereas orderers R and P may not require H/W_{Q} among H/W elements that order Q has obtained permission.

In this case, the MP-chip includes other common elements except S/W_{P}, H/W_{Q} and H/W_{R} in a single common unit, while S/W_{P} is in the individual unit of P, H/W_{Q} is in the individual unit of Q, H/W_{R} is included in the individual unit of R, respectively.

Accordingly, each individual unit of orderers P, Q, and R may execute a specific task by driving all common H/W elements or common S/W elements included in a single common unit.

In addition, orderers P, Q and R do not need to obtain permission for H/W elements or S/W elements, where individual units of their design do not need to run together.

The second embodiment of the second exemplary aspect is also for the security of various H/W elements or S/W elements included in the common unit of the MP-chip, wherein a plurality of common units are installed in the MP-chip, at least one common unit includes one or more H/W elements or S/W elements that are not included by other common units. For reference, this is similar to the configuration of FIG. 4.

For example, in the second detailed example of the first embodiment of the second exemplary aspect described above, the MP-chip may include S/W_{P}, H/W_{Q}, and H/W_{R} in the first common unit, while the second common unit may include S/W_{P}, H/W_{Q}, and H/W_{R}.

The MP-chip allows each individual unit to drive all common H/W elements or common S/W elements included in the first common unit, while each individual unit may selectively drive the S/W_{P}, H/W_{Q}, and H/W_{R} included in the second common unit.

For such selective driving, the MP-chip may include various security elements, which will be described in detail below.

As in the case of this embodiment, some of the plurality of H/W elements or S/W elements included in the MP-chip are common H/W elements or common S/W elements that all individual units need to drive together. On the other hand, there may be H/W elements or S/W elements that drive only some individual units.

For convenience of description, H/W elements or S/W elements driven by only some individual units will be referred to as “individual H/W elements” or “individual S/W elements,” These are collectively referred to as “individual elements.”.

If the number of these individual elements is small, an orderer or an MP-chip manufacturer that does not require the individual elements may obtain permission for the individual elements from another company

Thus, in this case, the MP-chip can be equipped with a single common unit and include all common elements, partial common elements and individual elements in the common unit.

However, even if the number of orderers is small, the nature of the product to be manufactured by each orderer is quite different, or even if the properties of the products designed by each orderer are different from each other, if the H/W element or S/W element they want to drive is different, the number of individual elements may increase.

In this case, instead of obtaining a license for a large number of individual elements from another company, the orderer or MP-chip manufacturer installs a common unit containing only common elements and one or more common units including individual elements as described above, thereby reducing the IP cost required for MP-chip manufacturing.

In the case of this embodiment, the MP-chip may include a single common unit instead of including a plurality of common units as described above, but a plurality of different sub-units are installed in the common unit, and a common element is installed in one part, and only partially common elements may be included in other parts.

On the other hand, in another area, only individual elements may be included. In this way, when a plurality of parts is installed in a single common unit, the MP-chip includes various security elements described below, so that each individual unit can selectively drive elements of different parts together.

The third embodiment of the second exemplary aspect of the present invention relates to the security of a specific individual unit included in the MP-chip, wherein one or more common units and a plurality of individual units are installed in the MP-chip, but a particular orderer may install his or her own security requirements in an individual unit designed by him/herself. As a result, a particular orderer may prevent other orderers from operating their individual units.

That is, the security element may act as a kind of authentication element. Accordingly, an order who wants to drive a specific individual unit on which the security element of a specific orderer is installed must provide his or her ID, predetermined password or signal, etc. to the security point. In this case, in order to improve the quality of security, the ID, password, signal, or other security information or authentication information may be used using various known encryption algorithms or scrambling algorithms.

If the ID, password, signal or other information provided by the orderer matches the ID, password, signal or other information set by a specific orderer, the specific individual unit will be operated, but if the ID, password, signal or other information provided by the orderer does not match the setting ID, password, signal or other information, the specific individual unit will not be operated.

The security element may be manufactured in the form of H/W or S/W, and various passwords, signals, or other security or authentication information used by known security devices or authentication devices for security or authentication may be used. Further description of this is omitted as the details of this are a known description.

If the ID, password, signal or other information provided by the user matches the ID, password, signal or other information set by a particular orderer, the MP-chip allows the user to drive a particular individual unit.

However, at this time, a specific individual unit may execute a specific operation desired by a specific orderer by driving various common, partial common or individual H/W elements or S/W elements included in one or more common units included in the MP-chip.

The first detail example of the third embodiment is an MP-chip including one or more security elements, wherein the security element of a specific orderer may be installed on a top, bottom, side, and the like of an individual unit designed by a specific orderer.

Of course, the structure or location of the security element may be different depending on whether the security element is H/W or S/W. For example, a security unit of a specific order may be installed in various locations of the MP-chip, isolated from individual units designed by a specific orderer.

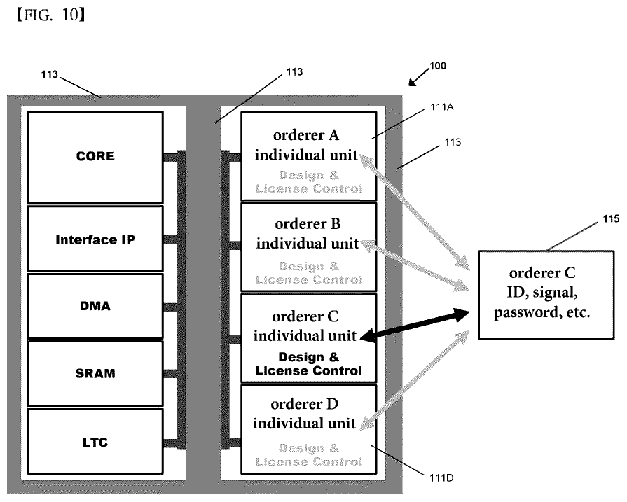

FIG. 9 is a schematic diagram of an exemplary MP-chip 100 that includes four individual units 111A, 111B, 111C, 111D, a single common unit 113, and four security elements 115A, 115B, 115C, 115D designed by four orderers A, B, C, and D, respectively.

In the case of the exemplary MP-chip 100 of FIG. 9, each security element 115A, 115B, 115C, and 115D is installed on the right side of each corresponding individual unit 111A, 111B, 111C, 111D. However, as described above, the security elements may be installed in a different arrangement at a location or arrangement different from the position or arrangement of FIG. 9.

For example, when orderer C intends to use the individual unit 111C designed by him/her, the orderer C transmits an ID, password, signal, or other information to the MP-chip 100 or to each individual unit 111A, 111B, 111C, 111D. The MP-chip 100, the control unit (not shown in FIG. 9) of the chip 100, or each individual unit 111A, 111B, 111C, 111D determines whether the transmitted ID, password, signal or other information matches the stored ID, password, signal or other information.

When the ID, password, signal or other information provided by the orderer C matches the stored ID, password, signal or other information, the MP-chip 100, the control unit of the chip 100, or the security element 115C may cause the orderer C to drive the individual unit 111C, but other individual units 111A, 111B, 111D may not drive.

The second detail example of the third embodiment is a security element provided as an object separate from the MP-chip. Therefore, the user may provide the ID, password, signal, or other information to the MP-chip or other information by physically coupled or electrically connecting the security element to the MP-chip. For this, the user may be equipped with an electrical line capable of transmitting ID, password, signal, or other information to an individual unit or security element of the MP-chip.

A third detailed example of the third embodiment is a security element stored in a server or the like physically separated from the MP-chip. In this case, the user can have the security element transmit passwords or signals to individual units of the MP-chip through well-known wireless communication.

In this detailed example, the security element may transmit passwords or signals to individual units of the MP-chip using known 5G or 4G mobile networks, wireless communication such as Bluetooth, FID, NFC, MST, and NFMI, infrared or ultraviolet communication, sound wave communication, etc. For this, the MP-chip or an individual unit designed by a specific orderer may include various H/W elements or S/W elements for transmitting and receiving the wireless communication.

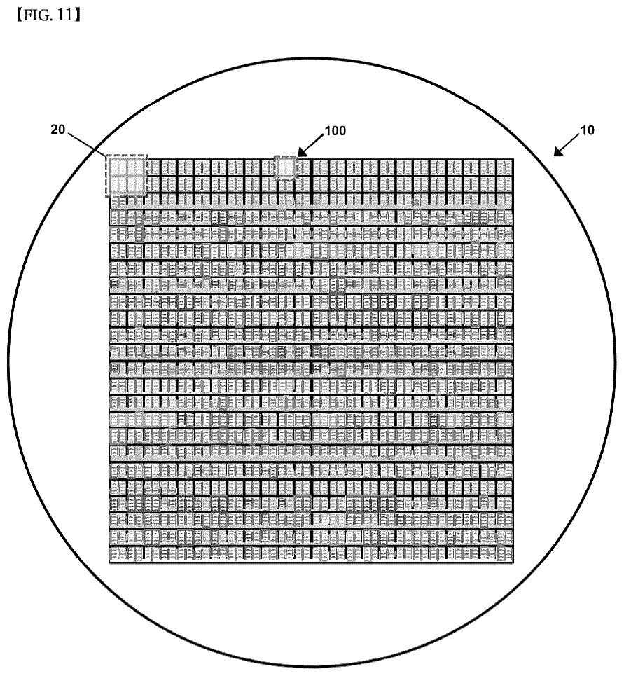

FIG. 10 is a schematic diagram of an exemplary MP-chip 100 including four separate units 111A, 111B, 111C, 111D, a single common unit 113, and a plurality of security elements designed by four orderers A, B, C, and D, respectively. In particular, each individual unit included in the MP-chip 100 of FIG. 10 is driven by security elements 115 that are separate objects from the MP-chip 100.

For example, when orderer C intends to use the individual unit 111C designed by him/her, orderer C electrically connects the security element 115, which is a separate object from the MP-chip 100, to the MP-chip 100 or is located within a distance capable of wireless communication. As a result, the MP-chip 100, the control unit of the chip 100 (not shown in FIG. 10), or the security element 115, etc., cause the orderer C to drive the individual unit 111C, but other individual units 111A, 111B, 111D may not drive.

However, the MP-chip 100 or the individual unit 111C may need to determine whether the user sending information through wireless communication is an orderer C or a hacker. For this, the MP-chip 100 or the individual unit 111C may need to include a minimum-security element for processing information transmitted to the wireless communication.

The fourth detail example of the third embodiment is when a plurality of security elements are installed in individual units designed by a specific orderer. For example, a specific orderer may install a plurality of security elements in series or parallel, and the user may drive the individual units only when all of the security elements are satisfied.

Alternatively, a specific orderer may include various H/W elements or S/W elements in an individual unit designed by the user, drive the first set of elements when the user satisfies the first security element, and drive the second set of elements different from the first set.

Alternatively, a specific orderer installs various H/W elements or S/W elements licensed by a plurality of other companies in an individual unit designed by the user, and when the user satisfies the first security element by transmitting a first password or signal, the elements licensed by the first third party are driven, If the user satisfies the second security element by transmitting the second password or signal simultaneously with the first password transmission or after the first password transmission, the second set of elements different from the first set may be operated simultaneously or sequentially.

The fifth detail example of the third embodiment is for the arrangement or installation of the security elements when multiple orderers each use their own security elements.

For example, although a plurality of orderers use their own security elements, the security elements are provided as a separate object from the MP-chip as in the second detail example described above, or as in the third detail example described above, when stored in a server or the like, which is physically isolated from the MP-chip, there is no particular problem in the arrangement or installation of a plurality of security elements.

However, as in the first detailed example described above, multiple security elements of a plurality of orderers are installed in the top, bottom, side, etc. of a plurality of individual units, or in isolation from individual units, it may occur when installed at various locations on the MP-chip.

In this case, if the plurality of security elements are smaller than the corresponding individual units, there is no particular problem in the arrangement or installation of the security elements and the electrical connection of the security elements and the individual units. However, when the length, area, etc. of the security element exceeds the length and area of the individual unit, there may be physical limitations to install multiple security elements on the MP-chip.

In this case, the orderers or MP-chip manufacturers can overcome the physical limitations by stacking multiple security elements. Alternatively, the MP-chip manufacturer may manufacture a plurality of security elements in the form of a separate chip, and overcome the physical limitation by connecting the MP-chip and the separate chip electrically or using wireless communication.

The fourth embodiment of the second exemplary aspect relates to the security of a plurality of individual units included in the MP-chip, in particular, various H/W structures and methods or S/W structures and methods in which an MP-chip manufacturer can drive individual units designed by each of multiple orderers but not individual units designed by other orderers.

In particular, the MP-chip manufacturer may include one or more control units in the MP-chip, and the control unit may use various H/W structures and methods or S/W structures and methods to drive only individual units designed by each orderer, but not to drive Individual units designed by other orderers.

The first detailed example of the fourth embodiment is a security structure and method for using control of a clock supplied to each security element. For example, a particular orderer transmits a specific signal or password to the MP-chip to drive an individual unit that he or she has established.

Upon receiving the MP-chip the specific signal or password, the security unit of the individual unit set up by a specific orderer may be activated using a control unit, but blocks the clock supplied to individual units or their security units designed by other orderers except for a specific orderer.

The second detailed example of the fourth embodiment is a security structure and method using control of a BUS interface. For example, a particular orderer transmits a specific signal or password to the MP-chip to drive an individual unit of his or her design.

Upon receiving the specific signal or the password, the MP-chip identifies a specific orderer, and uses the control unit to activate the BUS interface connected to the security unit of the individual unit designed by the specific orderer, but blocks the BUS interface connected to the individual units or their security units designed by other orderers except for the specific orderer.

The third detail example of the fourth embodiment is a security structure and method for directly controlling a power supply to each security element. For example, a particular orderer transmits a specific signal or password to the MP-chip to drive an individual unit of his or her design.

Upon receiving the specific signal or password, The MP-chip identifies a specific orderer, and uses the control unit to activate the security unit of an individual unit designed by a specific orderer, but blocks the power source supplied to individual units or their security units designed by other orderers except for a specific orderer.

The fourth detail example of the fourth embodiment is a security structure and method for directly manufacturing the security element itself. For example, a particular orderer transmits a specific signal or password to the MP-chip to drive an individual unit of his or her design.

Upon receiving the specific signal or password, the MP-chip identifies a specific orderer, and uses the control unit to activate the security unit of an individual unit designed by a specific orderer, but deactivates individual units or their security units designed by other orderers except for a specific orderer.

A particular orderer may access individual units or its security units designed by him according to the first to fourth detailed examples described above, but cannot access the security resources of other orderers, and thus cannot run individual units designed by other orderers.

The fifth detail of the fourth embodiment is to improve the reliability of security by using two or more of the security structures or methods illustrated in the first to fourth detailed examples described above.

Various embodiments of the MP-chip of the present invention, various units and elements thereof, structures, manufacturing methods or methods of use, and the like illustrated in the second exemplary aspect of the present specification may be variously modified or improved.

In the first embodiment of the modification or improvement of the second exemplary aspect, instead of using a separate control element, The structure and method of storing specific IDs, signals, passwords, and other security or authentication information in nonvolatile memory during the initialization stage of the MP-chip is described.

For example, a known large-scale chip does not include NOR flash inside, but installs NAND or NOR flash outside the body to control system programs, device drivers, and O/S of the AP including the CPU. In some cases, instead of installing NOR or NAND flash outside the chip, modules such as NOR flash modules or MCPs (multi-chip packages) can be installed inside the chip, or nonvolatile memory can be installed inside the package.

Therefore, when the MP-chip has the structure described above, the MP-chip may store the ID, signal, password, and other security or authentication information of a specific orderer in various elements such as a NOR flash module, an MCP module, or a nonvolatile memory instead of a separate control element. Thereafter, when any user transmits ID, signal, password, other security or authentication information, etc., the element may perform the function of the above-described security element by comparing it with the stored ID, signal, password, other security or authentication information, and the like.

The second embodiment of the modification or improvement of the second exemplary aspect may apply one or more of the various security structures or methods exemplified in the fourth embodiment when driving various partial common H/W elements, partial common S/W elements, and individual S/W elements included in a common unit of the MP-chip.

For example, when a specific orderer drives an individual unit designed by himself, the individual unit executes a specific task by driving one or more common, partially common, or individual H/W elements included in the common unit together.

In this case, the MP-chip uses the control unit described above to [1] control the clock supplied to each H/W element or S/W element, [2] control the connection of each H/W element or S/W element to the BUS interface, [3] directly control the power supply to each H/W element or S/W element, or [4] directly control each H/W element or S/W element itself. Thus, a particular orderer can control the operation of only H/W elements or S/W elements licensed from other companies.

The third embodiment of the modification or improvement of the second exemplary aspect is for an MP-chip using two or more security elements among the various embodiments and detailed examples of this second exemplary aspect.

For example, an MP-chip may include [1] the partial common elements included in a common unit or the security elements described above for individual elements, [2] the security elements described above for individual units, and [3] two or more of the above-described security elements for individual elements included in the individual unit.

As such, the MP-chip manufacturer may design a security structure and method for one or more common units, a plurality of individual units, common elements included in the units, partial common elements, or individual elements as needed.

The fourth embodiment of the modification or improvement of the second exemplary aspect is compatibility.

Each embodiment or detailed embodiment of the second exemplary aspect described above is [1] compatible with a different embodiment or detailed embodiment of the second exemplary aspect described above, or alternatively, [2] may be compatible with the embodiments or detailed examples of different aspects described above and described below.

Therefore, unless the specific structure or method of the various embodiments and detailed examples of the second aspect contradicts each other, aspect(s) of the present invention may be [1] applied to different embodiments of the same aspect or to the equivalent or similar structure or method of the detailed example, [2] applied to different embodiments of different aspects or equivalent or similar structures or methods of different detailed examples, [3] included in the corresponding or similar structure or method of [1] or [2] above, [4] substituted by the corresponding or similar structure or method of [1] or [2], [5] replaced by the corresponding or similar structure or method of [1] or [2], or [6] mixed with the corresponding or similar structure or method of [1] or [2].

A third exemplary aspect of the present invention relates to a connection unit that electrically connects various individual units and common units of the present invention, or electrically connects various common elements, partial common elements, or individual elements included in the units.

In the present specification, the term “electrical connection” of the two units refers to a connection through which [1] one unit may flow a current to another unit or a connection through which [2] one unit may maintain a voltage difference from the other unit.

The first embodiment of the third exemplary aspect may include a plurality of individual units and one or more common units, but one or more individual units are directly electrically connected to the common unit.

However, in this specification, a structure in which unit A and unit B are “directly electrically connected” refers to a structure in which one or more wires electrically connect unit A to unit B, but the wire does not electrically connect unit A to a different unit, for example, unit C.

Thus, a structure in which a specific individual unit and a common unit (one or more) are directly and electrically connected is defined as a structure in which the wire electrically connects the specific development unit to the common unit, but the wire does not electrically connect the particular individual unit to another individual unit.

However, even if there is a wire that directly electrically connects the particular individual unit to another individual unit, there may be a case in which the MP-chip manufacturer or orderer does not pass current or apply voltage to the wire.

For example, although the wire is generated during the MP-chip manufacturing process, even if the specific individual unit and the common unit are driven, there may be a case in which current flows or voltage does not need to be applied to the wire. In this case, the wire does not perform any function when driving the specific individual unit and the common unit. Thus, this particular individual unit can be considered to be directly electrically connected to the common unit despite the presence of the wire.

The second embodiment of the third exemplary aspect includes a plurality of individual units and one or more common units, but one or more individual units are indirectly electrically connected to the common unit.

However, in the present specification, the structure in which unit A and unit B are “indirectly electrically connected” refers to a structure in which one or more wires electrically connect unit A to unit B, as well as the unit A electrically connect to another unit, for example unit C.

Thus, a structure in which a single specific individual unit and (one or more) common units are indirectly electrically connected refers to a structure in which the wire electrically connects the particular development unit to the common unit, and the wire also electrically connects the particular individual unit to another individual unit.

For example, the edges of the exemplary MP-chips of FIG. 6, FIG. 9, and FIG. 10 may be regarded as BUS electrically connecting a plurality of individual units. Therefore, due to the BUS, it can be considered that the specific individual unit is indirectly electrically connected to a common unit of the MP-chip.

The MP-chip manufacturer may use the direct or indirect electrical connection illustrated in the first and second embodiments described above based on the structure, complexity, route width, and the like of the MP-chip.

In particular, the more the chip manufacturing process is refined, the more effective individual units can be included in a certain size MP-chip.

In this case, numerous wires may be required to directly electrically connect all of the individual units. Therefore, in this case, the individual units may be indirectly electrically connected.

Various embodiments of the MP-chip of the present invention, various units and elements thereof, structure, fabrication method or method of use thereof, etc. illustrated in the third exemplary aspect of the present specification may be variously modified or improved.

The first embodiment of a modification or improvement of the third exemplary aspect includes a plurality of individual units and one or more common units, wherein one or more individual units are directly electrically connected to the common unit, but another one or more individual units are indirectly electrically connected to the common unit MP-chip.

When utilizing direct or indirect electrical connections, MP-chip manufacturers can improve security by directly electrically connecting certain individual units with (one or more) common units, and the remaining individual units are indirectly electrically connected to (one or more) common units, and the necessary security elements can be installed to maintain a certain level of security.

The second embodiment of modification or improvement of the third exemplary aspect is compatibility. That is, each embodiment or detail example of the third exemplary aspect of the above description may be [1] compatible with different embodiments or detailed examples of the third exemplary aspect of the above, or [2] compatible with an embodiment or a detailed example of a different aspect of the above and below description.

Therefore, unless the specific structure or method of the various embodiments and detailed examples of the third aspect contradicts each other, the specific structure or method may be [1] applied to different embodiments of the same aspect or equivalent or similar structure or method of detailed examples, [2] applied to one embodiment or equivalent or similar structure or method of different detailed examples, [3] included in the corresponding or similar structure or method of [1] or [2] above, [4] substituted by the corresponding or similar structure or method of [1] or [2], [5] replaced by the corresponding or similar structure or method of [1] or [2], or [6] mixed with the corresponding or similar structure or method of [1] or [2].

A fourth exemplary aspect of the present invention relates to a wafer on which various MP-chips of the present invention are disposed. If prototypes based on different designs of multiple orders are requested, the MP-chip manufacturer reviews various H/W elements and S/W elements required to manufacture the prototypes.

The MP-chip manufacturer selects available elements developed by other companies from among the above elements, and allows the MP-chip manufacturer to obtain permission from the third party directly or by the orderers. Thereafter, the MP-chip manufacturer designs a common unit including the above elements, and designs an individual unit including elements of each orderer that are not included in the common unit. In this case, the various H/W elements or S/W elements included in the common unit may all be common elements.

In contrast, each orderer obtains a license for certain elements from the other company, and transmits to the MP-chip manufacturer a design for a common unit including the authorized elements and an individual unit including the remaining elements. MP-chip manufacturers assemble the designs of multiple orderers and then design a single, common unit. In this case, the common unit may include [1] only one or more common elements, [2] one or more common elements and one or more partial common elements, or [3] one or more common elements, one or more partial common elements, and one or more individual elements.

In the case of [1] of the above paragraph, all the elements included in the common unit are ball elements, so they correspond to elements that can be driven by all orderers. Therefore, additional security measures may not be necessary. However, in the case of [2] or [3] of the above paragraph, the MP-chip manufacturer may install various security elements described above so that each orderer can selectively drive the elements for which the orderer obtained permission.

In contrast, an MP-chip manufacturer may design multiple common units after aggregating the designs of multiple orderers. For example, an MP-chip manufacturer may design two common units, but the first common unit may include only one or more common elements, and the second common unit may include one or more partial common elements, one or more individual elements, but not a common element. Alternatively, according to the characteristics of each element, the second common unit may include one common element on it.

In contrast, an MP-chip manufacturer may design three common units after gathering the designs of multiple orderers. In this case, the first common unit may be designed to include only one or more common elements, the second common unit includes only one or more partial common elements, and the third common unit may be designed to include only one or more individual elements.

As such, MP-chip manufacturers may arrange various numbers of common units according to the number of common elements, partial common elements, or individual elements, structural characteristics, and difficulty of the design or process. Therefore, even if the orderers are the same and the product designs they order are the same, MP-chip manufacturers can deploy a single, two or more common units based on one of many different designs.

In addition, MP-chip manufacturers do not need to include specific common H/W elements or specific common S/W elements that all orderers require equally in specific common units. Similarly, MP-chip manufacturers do not need to include certain partial common H/W elements or specific partial common S/W elements that only some orderers require the same in specific common units.

For example, if it is helpful in design or process, MP-chip manufacturers can duplicate certain common elements or specific partial common elements in multiple common units. In addition, if it is helpful in the design or process, certain common elements or specific partial hollow elements may be placed only once or in duplicates on one or more individual units as well as in one or more common units.

After the design of the common unit is finished or in conjunction with the common unit design, the MP-chip manufacturer designs the individual units of each orderer. In addition, security units can be installed simultaneously with the design of individual units or after the installation is completed.

FIG. 11 is a schematic diagram of a wafer 10 in which the MP-chips 100 of FIG. 6 are disposed in a number of horizontal and vertical directions. In FIG. 6, 24×24, that is, 576 MP-chips 100 are arranged, but depending on the size of the MP-chip 100 and the diameter of the wafer, there may be thousands, tens of thousands, hundreds of thousands, or millions of MP-Chips 100 may be arranged.

A plurality of MP-chips 100 formed on a wafer 10 of FIG. 11 may be manufactured by repeating a single snapshot 20. In the case of FIG. 11, it is shown that four MP-chips 100 are manufactured with a single snapshot, but thousands, tens of thousands, hundreds of thousands, and millions of MP-chips 100 are produced with a single snapshot according to the size of the MP-chip 100. One or more MP-chips 100 may be fabricated.

Various embodiments of the MP-chip of the present invention, various units and elements thereof, structures, manufacturing methods or methods of use, and the like illustrated in the fourth exemplary aspect of the present specification may be variously modified or improved.

The first embodiment of a modification or improvement of the fourth exemplary aspect relates to the electrical connection of individual units and security elements.

The various security elements described above are each installed in a single individual unit or a single common unit. Thus, an MP-chip manufacturer produces an MP-chip that includes a plurality of individual units, one or more common units, and a plurality of security elements in a single MP-chip, according to a number of different designs designed by multiple orderers.

Accordingly, each orderer must provide his/her ID, signal, password, and other security or authentication information to the secure element each time to review an operation of individual units manufactured according to his/her design.

To alleviate this inconvenience, an MP-chip manufacturer can install [1] a single security element per multiple (e.g., M) MP-chips produced by a single snapshot, or [2] multiple security elements (e.g., N, only N<M) per MP-chip.

In addition, the need to duplicate the same security element is reduced by the above configuration, and the production time and cost of the MP-chip can be reduced accordingly.

The second embodiment of modification or improvement of the fourth exemplary aspect is compatibility. That is, each embodiment or detail example of the fourth exemplary aspect of the above is [1] compatible with different embodiments or detailed examples of the fourth exemplary aspect of the above, or [2] compatible with embodiments or detailed examples of different aspects of the above and below descriptions.

Therefore, unless the specific structure or method of the various embodiments and detailed examples of the third aspect contradicts each other, the specific structure or method of the various embodiments and detailed examples may be [1] applied to different embodiments of the same aspect or equivalent or similar structure or method of the detailed example, [2] applied to different embodiments of different aspects or equivalent or similar structures or methods of different detailed examples, [3] included in the equivalent or similar structure or method of [1] or [2] above, [4] replaced with the equivalent or similar structure or method of [1] or [2] above, [5] superseded by the corresponding or similar structure or method of [1] or [2] above, or [6] mixed with the corresponding or similar structure or method of [1] or [2].

Unless otherwise stated, the various characteristics of certain aspects, embodiments, detailed examples, or means illustrated herein may be compatibly applied to the corresponding characteristics of different aspects, embodiments, detailed examples or means of the present specification. However, the compatibility is only provided that the application, inclusion, substitution or mixing do not conflict with each other.

### EXPLANATION OF SYMBOL

10: wafer
20: snapshot
100: MP-chip
111: individual unit
111P, 111, 111R, 111S, 111A, 111B, 111C, 111D: individual unit
113: common unit
113A, 113B: common unit
115: security elements
115A, 115B, 115C, 115D: security elements

What is claimed is:

1. A multi-project chip, the multi-project chip comprising:
a first individual unit including at least one of a first hardware element and a first software element;
a second individual unit including at least one of a second hardware element and a second software element;
a common unit including at least one of the third hardware element and the third software element;
a first security element configured to receive a first signal for driving a first individual unit;
a second security element configured to receive a second signal for driving the second individual unit;
wherein the first security element allows the first individual unit to drive together with the common unit to execute the first operation upon receiving the first signal,
wherein the second security element allows the second individual unit to drivee
together with the common unit to execute a second operation upon receiving the second signal.

2. The multi-project chip of claim 1,
wherein the first individual unit is not driven with the second individual unit when executing the first operation.

3. The multi-project chip of claim 1,
wherein even if the first individual unit is driven together with the second individual unit, the first operation cannot be executed.

4. The multi-project chip of claim 1,
wherein the first individual unit does not include the second hardware element and the second software element.

5. The multi-project chip of claim 1,
wherein the second individual unit is a multi-project chip not including a third hardware element and a third software element.

6. The multi-project chip of claim 1,
wherein the first individual unit is driven together with the common unit to execute a first operation, but one of the third hardware element and the third software element is not driven.

7. The multi-project chip of claim 1,
wherein the first individual unit is not directly electrically connected to the second individual unit.

8. The multi-project chip of claim 1,
wherein the first individual unit is not indirectly electrically connected to the second individual unit.

9. The multi-project chip of claim 1, further comprising:
an additional common unit,
wherein the additional common unit includes one or more of a fourth hardware element and a fourth software element,
wherein the first individual unit is driven together with the common unit and the additional common unit to execute the first operation.

10. The multi-project chip of claim 1,
wherein the first security element is located in one of the upper, side and lower portions of the first individual unit.
